(19) United States
(12) Patent Application Publication
(10) Pub. No.: US 2013/0318095 A1
(43) Pub. Date: Nov. 28, 2013

(54) DISTRIBUTED COMPUTING ENVIRONMENT FOR DATA CAPTURE, SEARCH AND ANALYTICS

(71) Applicant: WaLal Inc., (US)

(72) Inventor: Michael Harold, Shreveport, LA (US)

(73) Assignee: WaLa! Inc., Bossier City, LA (US)

(21) Appl. No.: 13/891,424

(22) Filed: May 10, 2013

Related U.S. Application Data
(60) Provisional application No. 61/646,610, filed on May 14, 2012.

(51) Int. Cl. G06F 17/30

(52) U.S. Cl. CPC G06F 17/30424
USPC 707/741

(57) ABSTRACT

An application engine of a distributed data management system includes acquisition applications which execute to obtain portions of source data from different data sources. Each portion of source data is mapped to an interlingual representation. The application engine transmits data objects including the portions of source data and corresponding interlingual representations to a data container. For each data object, the data container stores the source data and the interlingual representation in one or more databases. The data container also parses the source data of the data object according to one or more of a full-text indexing technique, a semantic indexing technique, or a structured metadata indexing technique, and stores the indexed data. A database client may receive a search query and search the source data and interlingual representations stored in the databases.

### PRIORITY INFORMATION

This application claims priority to U.S. Provisional Patent Application No. 61/646,610, titled “A Distributed Computing Environment for Data Capture, Search and Analytics,” filed May 14, 2012, whose inventor was Michael Harold.

### BACKGROUND OF THE INVENTION

1. Field of the Invention

This invention relates generally to the management of computer data. More particularly, the invention relates to a system and method for electronically capturing both structured and unstructured data from multiple data sources and storing, indexing, searching, and analyzing the data from multiple physical databases over a computer network using a distributed service architecture.

2. Description of the Related Art

Computer data is a very important part of business operations. The ability to capture structured data at it the time it is created and share that data with multiple, heterogeneous computing environments in the context of distributed transactions came to maturity with the arrival of Enterprise Application Integration (EAI) architectures in the 1990s. These architectures provided connectivity with multiple data sources from different organizations and allowed the data to be captured as soon as it was created. More importantly, these architectures solved the N-squared problem that existed between multiple participants in a distributed transactional environment. The number of data connectors needed to provide a shared syntax among disparate computing environments is (N(N−1)/2) where N equals the number of data sources. As example, with 12 data sources, the number of point-to-point data connectors needed are ((12×11)/2) or 66 connectors. EAI solved this problem by providing a domain-specific interlingua that all data sources in a given transactional environment shared. Incoming data from each data source was translated to an interlingual representation understood by all data source connectors. This reduced the total number of connectors needed to N+1 and made possible the real time participation between many structured data sources in distributed transactions. Early companies and products that provided solutions in this space include Active Software, Vitria, Tibco, NEON and Microsoft's BizTalk Server.

The ability to capture unstructured data and make that data easily available to users is based on search technology. The history of computer based search technology for unstructured data dates from the 1960s with Gerard Salton's SMART informational retrieval system. In the 1990s companies such as Excite, AltaVista, Ask.com and Yahoo used search as the primary form of interaction with the Internet user community. Presently, Internet search is dominated by Google.

Enterprise search is different from Internet search in that enterprise search solutions attempt to use both unstructured and structured data sources as input. Enterprise search collects unstructured data from multiple data sources and indexes that data to make it searchable using a variety of techniques. One technique, fulltext search, normalizes the unstructured data using techniques that include stemming, lemmatization and part of speech extraction. The normalized data is then stored in indexes that provide the ability to search the data using token types. Token types include integers, floating point numbers, dates, times, words, email addresses, uniform resource locators (URLs) and file names as examples. Another technique, semantic search, identifies search items by determining the semantic context of the search terms in the search query. For example, the term “tree” has ambiguity in its meaning as in “a plant with a trunk, limbs and leaves”, a “family tree”, something resembling a tree such as a “clothes tree” or “crosstree”, or a mathematical or grammatical “tree diagram.” Semantic search uses a variety of mathematical methods including path traversal, logical inference and graph pattern matching to disambiguate search terms. Enterprise search vendors and products for unstructured search include Apache Solr, Apache Lucene, Autonomy, EMC, Google, IBM, Microsoft, Oracle and SAP.

Connectors for unstructured data in the enterprise search space are similar to the connectors found in the EAI space. Structured data connectors are configured to capture database transactions and translate the data from those transactions into domain specific representations for domains such as finance, manufacturing, point of sale, supply chain management, and healthcare. This translated data takes the form of searchable meta-data which is stored in one or more databases.

Search data is often used as input to analysis for purposes of both identifying and understanding patterns in the data. These patterns are used for prediction and decision making The effort is referred to collectively as data analysis or data analytics. Data analytics often requires that a collection of data be made available as input to a variety of decision makers that include business executives, business analysts and data scientists. Executive decision makers require the ability to see data in the forms of dashboards that contain graphs, reports and descriptive statistics. Business analysts require that the data be available for reporting purposes and as input to statistical analysis that is both descriptive and inferential. Data scientists generally require that large volumes of data be organized as input to data mining processes for purpose of both short term and long term prediction. The results of data analysis efforts are often output as visual representations that include lists, graphs, maps and charts that provide answers, tell stories or both.

None of the above mentioned approaches establishes a methodology and/or system which supports storage, index, search and retrieval of complex data schemas, data elements, data documents and/or software objects, hereinafter referred to collectively as the “data,” in a distributed network computing environment. Additionally, none of the prior approaches allows the data to be accessed using a global, network-wide naming convention such as JavaScript Object Notation (JSON), or to be stored, indexed, searched, retrieved and analyzed using user-defined meta-data, or to be described as complex semantic data schemas using Resource Description Framework (RDF), or to be searched using any combination of fulltext search, semantic search and structured meta-data search, the results of which may be displayed in a browser, exported as reports or data sets or made available to third party analytics and visualization tools. Finally, in the case of complex software objects such as those related to finance, manufacturing, supply chain management, communications and healthcare, none of the above references allow these complex software objects to be stored, searched and retrieved in combination with unstructured data.

There is, therefore, a present need to provide an improved paradigm for acquiring, indexing, searching and retrieving both unstructured and structured data in a distributed, network-based, computing environment.

### SUMMARY

Various embodiments of a distributed data management system and associated methods are disclosed. According to some embodiments, the distributed data management system may implement an application engine and a data container. The application engine may be executable to obtain a plurality of portions of source data from one or more data sources. For each respective portion of source data, the application engine may map at least a subset of the source data to an interlingual representation and transmit, to the data container, a data object including the source data and the interlingual representation.

The data container may be executable to receive the data objects transmitted by the application engine. For each data object, the data container may store the source data of the data object and the interlingual representation of the source data in one or more databases. The data container may parse the source data of the data object according to one or more of a full-text indexing technique, a semantic indexing technique, or a structured metadata indexing technique. The parsing may produce indexed data, which the data container may store in the one or more databases. In some embodiments, the data container may parse the source data of a given data object according to all three of the full-text indexing technique, the semantic indexing technique, and the structured metadata indexing technique.

In some embodiments the application engine may include a plurality of acquisition applications. Each acquisition application may correspond to a particular data source and may be executable to obtain source data from the particular data source. In some embodiments, source data obtained from different data sources and/or the corresponding interlingual representations may be stored in separate databases. For example, the data container may receive a first data object including a first portion of source data obtained from a first data source and a second data object including a second portion of source data obtained from a second data source. The source data of the first data object may be stored in a first one or more databases corresponding to the first data source, and the source data of the second data object may be stored in a second one or more databases corresponding to the second data source.

In some embodiments, a data object transmitted by the application engine to the data container may include a manifest, and the interlingual representation may be included in the manifest. The manifest may also include other information. For example, in some embodiments the manifest may include instructions informing the data container where the source data and/or interlingual representation should be stored, e.g., which database(s). For example, the manifest of a first data object may direct the data container to store the source data of the first data object in a first one or more databases, and the manifest of the second data object may direct the data container to store the source data of the second data object in a second one or more databases.

The distributed data management system may further include a database client. The database client may be executable to receive a search query directed to the one or more databases, search the one or more databases in accordance with the search query, and return result information indicating a result of searching the one or more databases. Searching the one or more databases may include searching both source data and interlingual representations stored in the one or more databases. In some embodiments the database client may be executable to receive and perform any combination of a full-text search query, semantic search query, or structured metadata search query.

As discussed above, data stored by the data container may be distributed across multiple databases. Thus, when performing a search, the database client may search multiple databases, and the result information may include aggregated search results from at least two databases.

### BRIEF DESCRIPTION OF THE DRAWINGS

A better understanding of the invention can be obtained when the following detailed description is considered in conjunction with the following drawings, in which:

FIGS. 1-5 illustrate embodiments of a distributed data management system;

FIG. 6 is a flowchart diagram illustrating one embodiment of a method that may be performed by an application engine of the distributed data management system;

FIG. 7 is a flowchart diagram illustrating one embodiment of a method that may be performed by a semantic data container of the distributed data management system;

FIG. 8 is a flowchart diagram illustrating one embodiment of a method that may be performed by a database client of the distributed data management system;

FIG. 9 illustrates one embodiment of a computer which may execute software that implements functionality performed by the distributed data management system; and

FIG. 10 is a block diagram of a computer accessible storage medium that stores software including program instructions executable by one or more processors to implement operations of the distributed data management system.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the spirit and scope of the present invention as defined by the appended claims.

### DETAILED DESCRIPTION

### Definition of Terms:

To avoid any confusion and to aid in the understanding of the invention, the following definitions of terms used herein are provided:

“Application Engine” means the software executable to capture data from one or more data sources, translate it into interlingual representations, and transmit the data and interlingual representations to the Semantic Data Container. It includes one or more Acquisition Apps and the Sandbox. The Application Engine may execute on one or more computers or virtual machine instances.

Acquisition Application (“App”) means a software module that acquires the data from a data source, translates the data into one or more interlingual representations, packages the results into a data object including a Manifest and a Source Document, and transmits the results to the Semantic Data Container. The major components of the App are the Connector, the Mapper and the Loader. Acquisition Applications are also referred to herein as “Apps.”

“Sandbox” means the collection of software that provides the environment whereby a developer may create instances of an App and test the operation of its Connector, Mapper and Loader prior to making the App operational.

“Semantic Data Container” means the software executable to receive the data objects from the Application Engine, index the data, and store the original data, interlingual representations, and indexed data in one or more databases. It includes one or more Archivers and one or more Indexers. The Semantic Data Container may execute on one or more computers or virtual machine instances, which may be different than the one or more computers or virtual machines that execute the Application Engine, and may be coupled to them via a network.

“Archiver” means the collection of software that stores the Source Documents received from the Application Engine.

“Indexer” means the collection of software that parses the Manifest and the Source Document and indexes and stores the results in one or more fulltext data stores, one or more semantic data stores and one or more meta-data data stores.

“Knowledge Domain” means any well-defined sphere of activity or field of knowledge that may be described using terms, definitions and relationships understood by participants and persons skilled in the art in that sphere of activity or field of knowledge. An example of Knowledge Domain includes business activities such as finance, manufacturing, logistics, insurance, digital communications, etc. Other examples of Knowledge Domain may include activities or fields of knowledge such as life sciences, education, physics, etc.

“Interlingual Representation” means a Knowledge Domain specific representation of data. Generally speaking, an Interlingual Representation may include (1) one or more objects (i.e., data structures and their associated attributes) each of which may be derived from an abstract class (i.e., a description of the data types or attributes associated with the object), (2) the relations that are defined for those objects' data types or attributes, and (3) the rules (i.e., actions, program functions, object methods, etc.) that accompany the use of the attributes and relations associated with the objects. An Interlingual Representation may enable management of state changes resulting from each instance of input into or output from the Semantic Data Container using a combination of translation schemas and software methods or functions each of which in turn may access one or more rule bases and/or expert systems.

“Data Source” means any computer or network computing environment that outputs data (or otherwise makes data available) to an App (e.g., within the Application Engine). Data sources include, but are not limited to databases, network connections, software objects, Representation state transfer (REST) interfaces, websites, web services, file systems, directory services and mobile devices.

The following detailed description is presented to enable any person skilled in the art to make and use the invention. For purposes of explanation, specific nomenclature is set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the spirit and scope of the invention. The present invention is not intended to be limited to the embodiments shown, but is to be accorded the widest possible scope consistent with the principles and features disclosed herein.

Various embodiments are described of methods for using computers and software in a network environment to obtain data from one or more data sources using one or more data connectors, mapping some or all data source data to one or more interlingual data representations and transmitting both the mapped data and the original data to a Semantic Data Container capable of archiving, indexing and storing both the source data and indexed data in one or more databases. In particular, systems, methods and apparatus are described whereby the user or users of the system are able to store, index, search and retrieve data from multiple data sources. The search and retrieval of said data can be accomplished using any combination of fulltext search, semantic search and meta-data search to identify, locate and retrieve the data. Furthermore, the same search methods may be used to create data sets for use by other systems and programs.

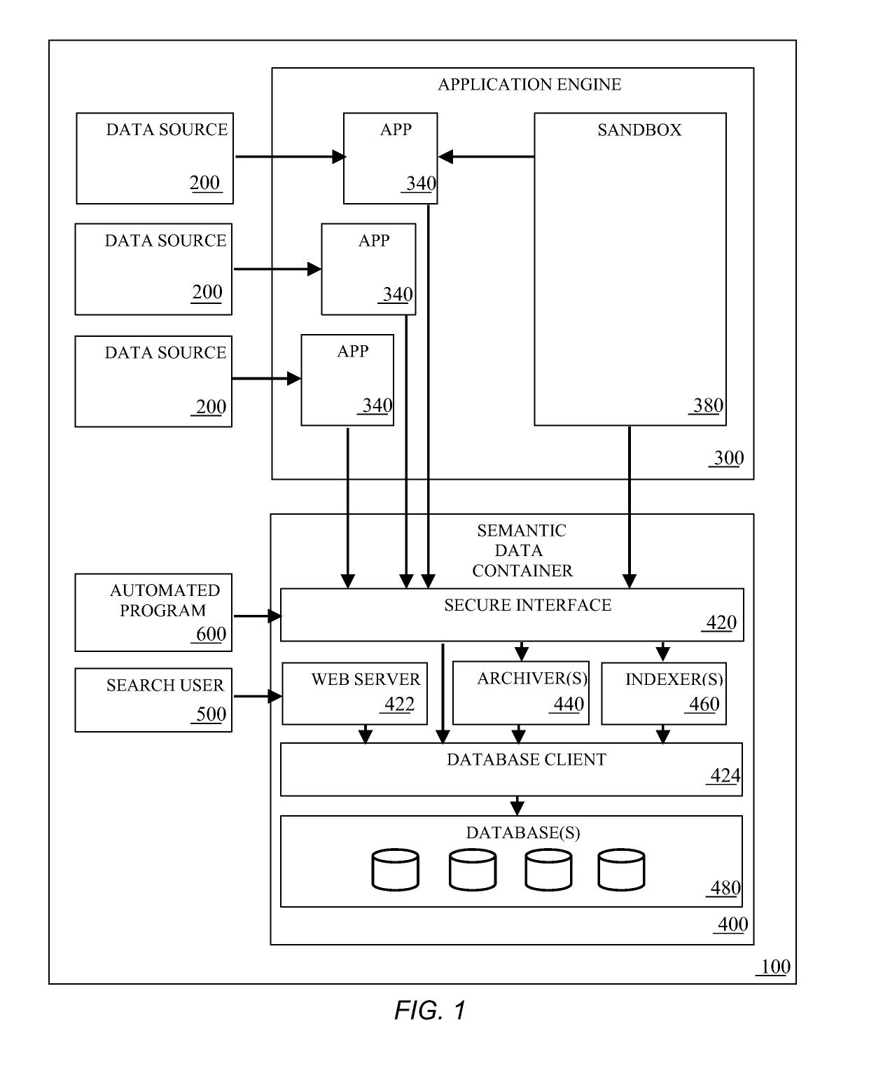

With reference now to FIG. 1 of the Drawings, there is illustrated therein a distributed data management system, generally designated by the reference numeral 100. An Application Engine 300 containing one or more Apps 340, each App 340 able to communicate with a given Data Source 200, obtains data from the Data Source 200 using one or more methods applicable to the Data Source 200. Once the data is obtained from the Data Source 200, the App 340 maps some or all of the data to an interlingual representation and transmits both the mapped data and the original source data to a Semantic Data Container 400 through a Secure Interface 420.

Data received from the App 340 by the Semantic Data Container 400 through the Secure Interface 420 is transmitted to an Archiver 440 and Indexer 460. The Archiver 440 stores both the mapped data and the original source data in one or more locations specified by the user. The Indexer 460 stores the mapped data provided by the App 340 in one or more databases and parses the source data using a variety of techniques including fulltext indexing, semantic indexing and domain specific meta-data indexing. Once parsed and indexed, the resulting data is also stored by the Indexer 460, using a database client 424 in one embodiment, in one or more databases.

Upon completion of this process, the data is available for search, reporting and analytics purposes by a Search User 500. The Search User 500 accesses the data through a Web Server 422 using a browser. Queries from the Search User 500 are processed by a Database Client 424 providing fulltext search, semantic search and domain specific meta-data search capabilities in any combination. The data returned by the search may be displayed in the Search User's 500 browser or exported to a location specified by the Search User 500. Alternatively, an Automated Program 600 may be used to query the data and extract search results in the forms of lists, reports or data sets.

A Sandbox 380 is contained within the Application Engine 300 for purposes of testing each App 340 created by a developer. The Sandbox 380 contains the software tools necessary to create an App 340. The Sandbox 380 also contains an instance of a Semantic Data Container 400 provided specifically for the purpose of allowing a developer to test and verify each step of the data acquisition, mapping, loading, archiving, indexing and search process prior to making the App 340 operational.

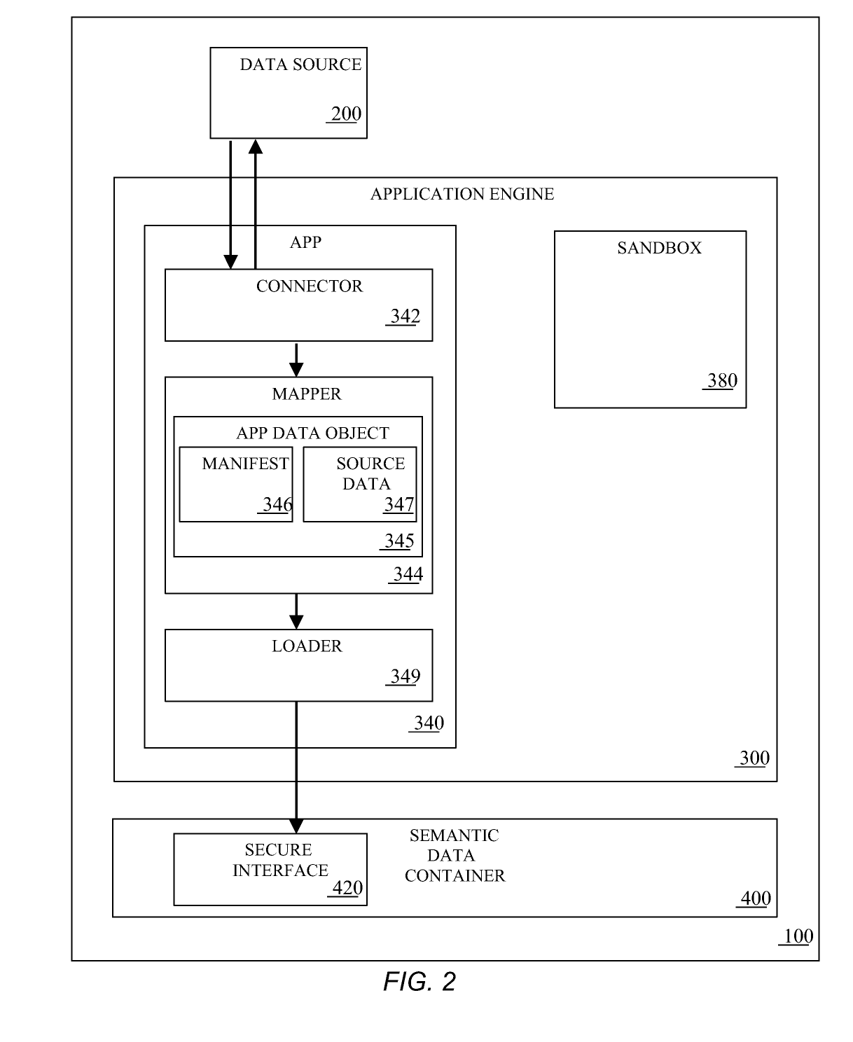

With reference now to FIG. 2 of the Drawings, there is illustrated therein a distributed data management system, generally designated by the reference numeral 100. An App 340 within the Application Engine 300 uses a Connector 342 to communicate with a Data Source 200, obtaining data from the Data Source 200 using one or more methods applicable to the Data Source 200. Such methods for obtaining data from the Data Source 200 may actively pull data from the Data Source 200 or passively receive data from the Data source 200, or both. An example of actively pulling data from the Data Source 200 is the use, by the Connector 342, of event triggers and stored procedures to obtain data from a relational database as is the case with data sources such as Microsoft SharePoint. An example of passively receiving data from the Data Source 200 is the use, by the Connector 342, of network connections to obtain data from a socket connection as is the case with data sources such as Twitter. Another example of passively receiving data from the Data Source 200 is the use, by the Connector 342, of a SMTP proxy that receives emails via journaling on the part of an email server.

Once data is received from the Data Source 200 by the Connector 342, the Connector 342 makes the data available to the Mapper 344. In various embodiments, the Mapper 344 is configured to convert the source data into two objects, collectively referred to as the App Data Object 345 that will be made available to the Loader 349. The first of the two objects is the Manifest 346. The Manifest may be represented as one or more files. The file(s) may be in various formats. In some embodiments the Manifest 346 is a file containing information in Resource Description Framework (i.e., RDF) format. This information can be of any type including but not limited to identifiers for the source data, datetime stamps for the source data, archive storage destinations for the source data, meta-data associated with a source document contained in the source data but not contained in the source document, and domain specific interlingual representations of data contained in the source data. The other component of the App Data Object 345 is the unmodified Source Data 347 obtained from the Data Source 200.

Once the Mapper 344 completes its work, the App Data Object 345 is made available to the Loader 349. The Loader 349 transmits the App Data Object 345 to the Semantic Data Container 400 via the Secure Interface 420. In the context of an operational environment, the Sandbox 380 is not active.

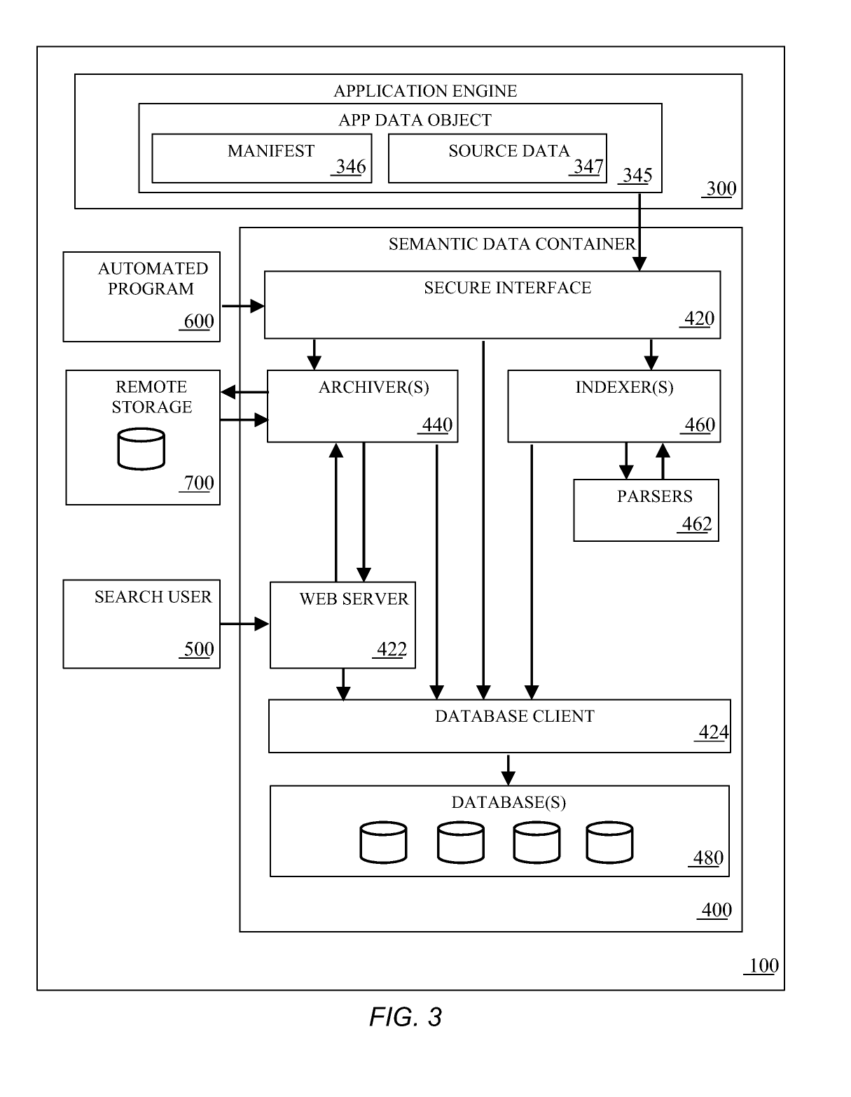

With reference now to FIG. 3 of the Drawings, there is illustrated therein a distributed data management system, generally designated by the reference numeral 100.

Data is obtained from the Application Engine 300 by the Semantic Data Container 400 through a Secure Interface 420 where it is transmitted to an Archiver 440 and Indexer 460. The Archiver 440, based on instructions contained in the Manifest 346, stores the Manifest 346 in the Semantic Data Container's 400 Databases 480, the Remote Storage 700, or in both locations. The Archiver 440, based on instructions contained in the

Manifest 346, stores the Source Data 347 in the Semantic Data Container's 400 Databases 480, the Remote Storage 700, in both locations, or not at all. The location of the Manifest 346 and Source Data 347 is maintained in the Semantic Data Container's 400 Databases 480.

When a Search User 500 queries the Semantic Data Container 400 via the Web Server 422, access to both the Manifest 346 and Source Data 347 is provided through the Archiver 440. Based on location data stored in the Semantic Data Container's 400 Databases 480, the Manifest 346 and Source Data 347 is made available to the Search User 500 for viewing via the Web Server 422. An Automated Program 600 may also access the Archiver 440, Indexer 460 and Parser 462 components of the Semantic Data Container 400 in any combination using the Secure Interface 420. This access of the Semantic Data Container 400 by an Automated Program 600 integrates the features of the Semantic Data Container 400 with external systems to both search and extract data for purposes that include but are not limited to systems reporting, systems integration and data analytics.

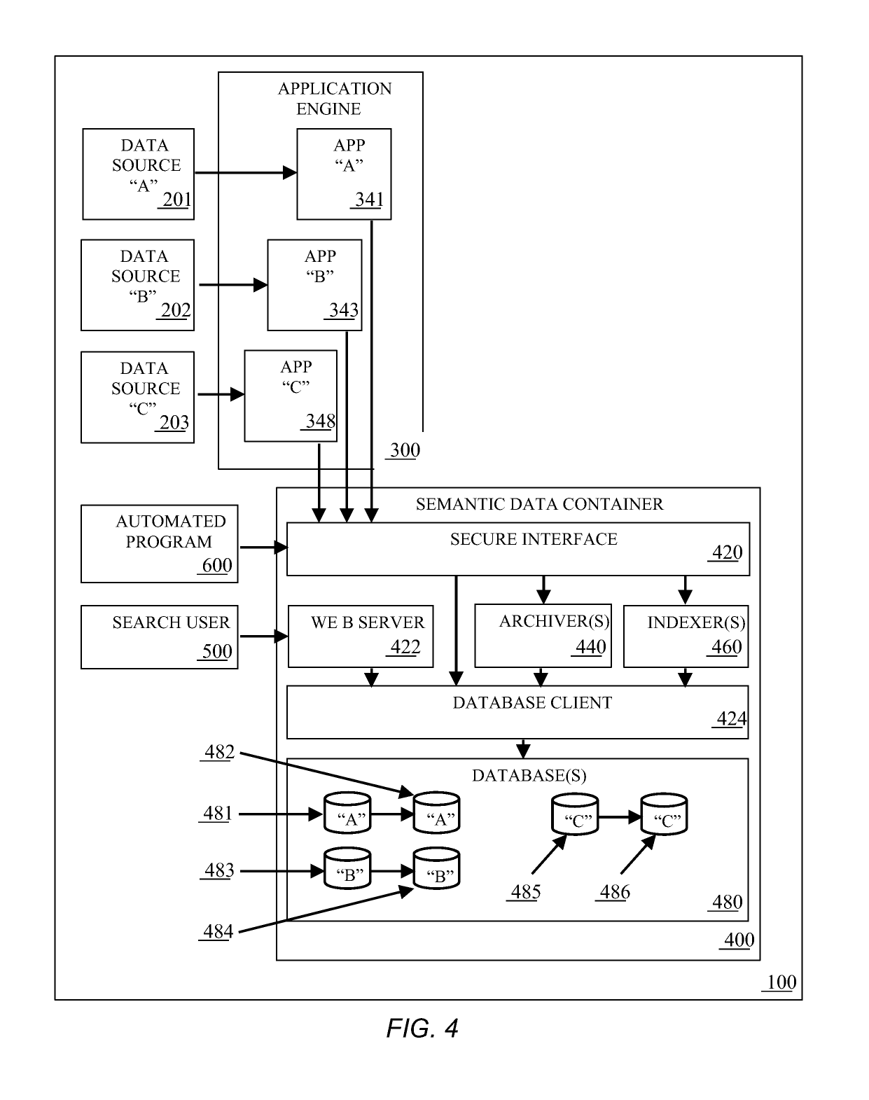

With reference now to FIG. 4 of the Drawings, there is illustrated therein a distributed data management system, generally designated by the reference numeral 100. An Application Engine 300 is shown to include an App “A” 341, an App “B” 343 and an App “C” 348. In the example shown, using App “A” 341 as the connector for Data Source “A” 201, App “B” 343 as the connector for Data Source “B” 202 and App “C” 348 as the connector for Data Source “C” 203, their data is transmitted to a Semantic Data Container 400 through a Secure Interface 420.

Data received from the App “A” 341 by the Semantic Data Container 400 through the Secure Interface 420 is transmitted to an Archiver 440 and Indexer 460. The Archiver 440 stores both the mapped data and the original source data in one or more locations which may be specified by the user. The Indexer 460 stores the mapped data provided by the App “A” 341 in database “A” 481 and parses the source data using a variety of techniques including fulltext indexing, semantic indexing and domain specific meta-data indexing. Once parsed and indexed, the resulting data is also stored by the Indexer 460 in database “A” 481. In various embodiments, all data stored in database “A” 481 is replicated in a copy of database “A” 482 at the time it is stored.

Data received from the App “B” 343 by the Semantic Data Container 400 through the Secure Interface 420 is transmitted to an Archiver 440 and Indexer 460. The Archiver 440 stores both the mapped data and the original source data in one or more locations specified by the user. The Indexer 460 stores the mapped data provided by the App “B” 343 in database “B” 483 and parses the source data using a variety of techniques including fulltext indexing, semantic indexing and domain specific meta-data indexing. Once parsed and indexed, the resulting data is also stored by the Indexer 460 in database “B” 483. All data stored in database “B” 483 is replicated in a copy of database “B” 484 at the time it is stored.

Data received from the App “C” 348 by the Semantic Data Container 400 through the Secure Interface 420 is transmitted to an Archiver 440 and Indexer 460. The Archiver 440 stores both the mapped data and the original source data in one or more locations specified by the user. The Indexer 460 stores the mapped data provided by the App “C” 348 in database “C” 485 and parses the source data using a variety of techniques including fulltext indexing, semantic indexing and domain specific meta-data indexing. Once parsed and indexed, the resulting data is also stored by the Indexer 460 in database “C” 485. All data stored in database “C” 485 is replicated in a copy of database “C” 486 at the time it is stored.

As data is indexed, it becomes immediately available for search, reporting and analytics purposes by a Search User 500. The Search User 500 accesses the data through a Web Server 422 using a browser. Queries from the Search User 500 are processed by a Database Client 424 providing fulltext search, semantic search and domain specific meta-data search capabilities in any combination. Queries from the Search User 500 may span any or all of the replicated databases in any combination as required. For example, should the Search User 500 decide to query data that originated from Data Source “A” 201, the search query generated by the Database Client 424 would query and return results from the replicated Database “A” 482. Should the Search User 500 decide to query data that originated from Data Source “B” 202 and Data Source “C” 203 the search query generated by the Database Client 424 would query and return a single set of results from the replicated Database “B” 484 and the replicated Database “C” 486. Should the Search User 500 decide to query data that originated from all data sources, in this case Data Source “A” 201, Data Source “B” 202 and Data Source “C” 203, the search query generated by the Database Client 424 would query and return a single set of results from all replicated databases, in this case the replicated Database “A” 482, Database “B” 484 and the replicated Database “C” 486.

The number of Database(s) 480 used is not limited except by the ability of the hardware and software to provide addressable storage space and the ability of the software to direct a database query or queries to multiple database instances and to consolidate the returned data into a single set of results. Data returned by the search may be displayed in the Search User's 500 browser or exported to a location specified by the Search User 500. Alternatively, an Automated Program 600 may be used to query the data and extract search results in the forms of lists, reports or data sets.

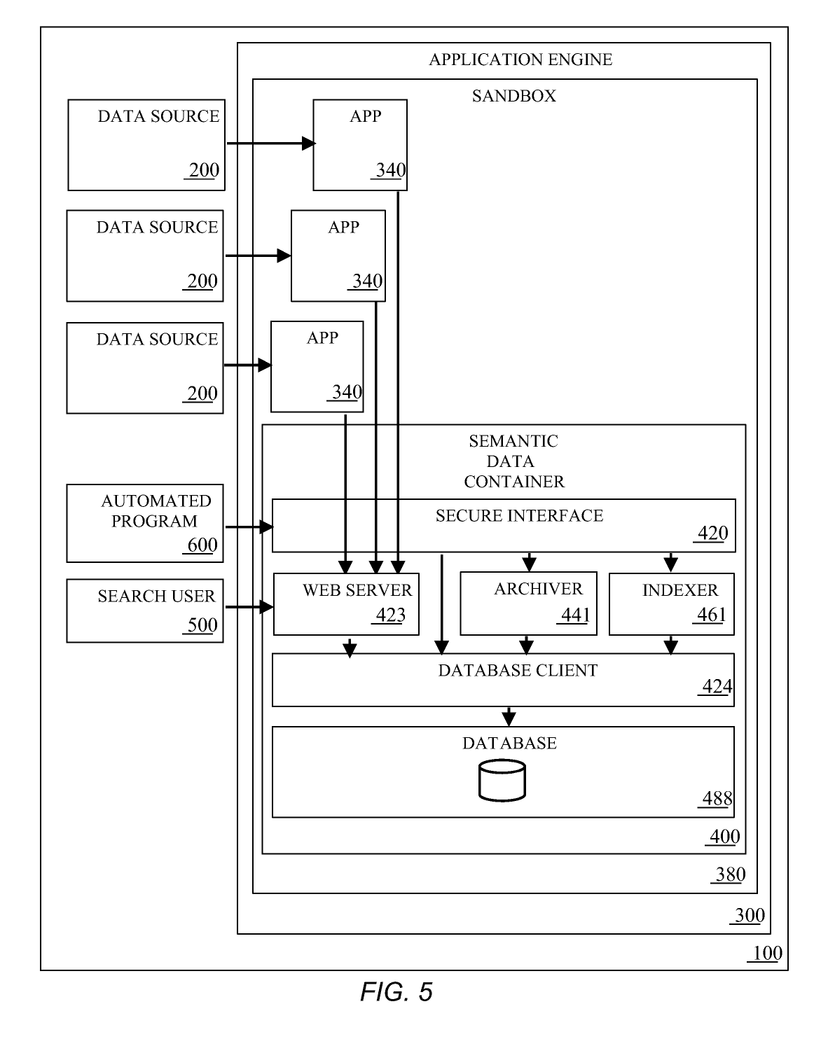

With reference now to FIG. 5 of the Drawings, there is illustrated therein a distributed data management system, generally designated by the reference numeral 100. An Application Engine 300 contains a Sandbox 380. The Sandbox 380 is configured to enable testing of components of the system including those components contained in the Application Engine 300 and their interaction with those components contained in the Semantic Data Container 400.

The Sandbox 380 provides tools for the prototyping of one or more Apps 340, each App 340 able to communicate with a given Data Source 200 and to obtain test data from the Data Source 200 using one or more methods applicable to the Data Source 200. Once the data is obtained from the Data Source 200, the App 340 maps some or all of the data to an interlingual representation and transmits both the mapped data and the original source data to a Semantic Data Container 400 contained within the Sandbox 380 through a Secure Interface 420 contained within the Sandbox 380.

Data received from the App 340 by the Semantic Data Container 400 through the Secure Interface 420 is transmitted to a single instance of an Archiver 441 and a single instance of an Indexer 461. The Archiver 441 stores both the mapped data and the original source data in one or more locations specified by the user. The Indexer 461 stores the mapped data provided by the App 340 in the single Database 488 contained within the Sandbox 380 and parses the source data using a variety of techniques including fulltext indexing, semantic indexing and domain specific meta-data indexing. Once parsed and indexed, the resulting data is also stored by the Indexer 461 in the Database 488.

Upon completion of this process, the data is available for search, reporting and analytics purposes by a Search User 500. The Search User 500 accesses the data through a Web Server 423 contained within the Sandbox 380 using a browser. Queries from the Search User 500 are processed by a Database Client 424 providing fulltext search, semantic search and domain specific meta-data search capabilities in any combination. The data returned by the search may be displayed in the Search User's 500 browser or exported to a location specified by the Search User 500. Alternatively, an Automated Program 600 may be used to query the data and extract search results in the forms of lists, reports or data sets.

Using this process, the Sandbox 380 provides an environment to allow a developer to test and verify each step of the data acquisition, mapping and loading process in an App 340 and to test and verify each resulting step of the archiving, indexing and search process within a Semantic Data Container 400 prior to making the App 340 operational.

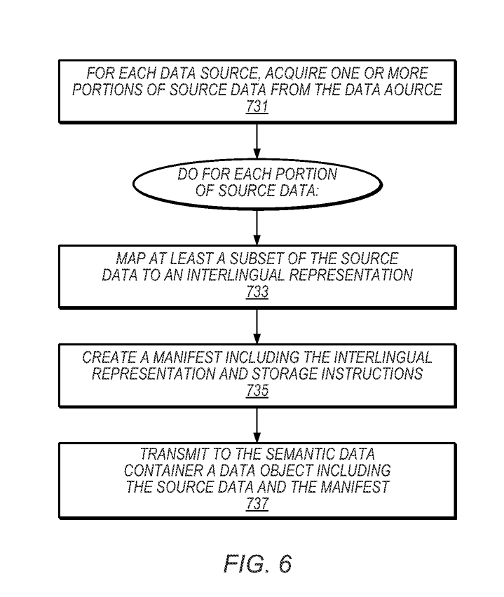

FIG. 6 is a flowchart diagram illustrating one embodiment of a method that may be performed by the application engine of the distributed data management system. The flowchart blocks of FIG. 6 illustrate logical operations that may be performed by the application engine, and in various embodiments of the method, some of the operations may be combined, omitted, modified, or performed in different orders than shown.

For each data source, the application engine may acquire one or more portions of source data from the data source (block 731). For each portion of source data, the application engine may perform the following: map at least a subset of the source data to an interlingual representation (block 733); create a manifest including the interlingual representation (block 735); and transmit to the semantic data container a data object including the source data and the manifest (block 737). The manifest may also include storage instructions informing the semantic data container where to store the information of the data object, as well as other information such as described above.

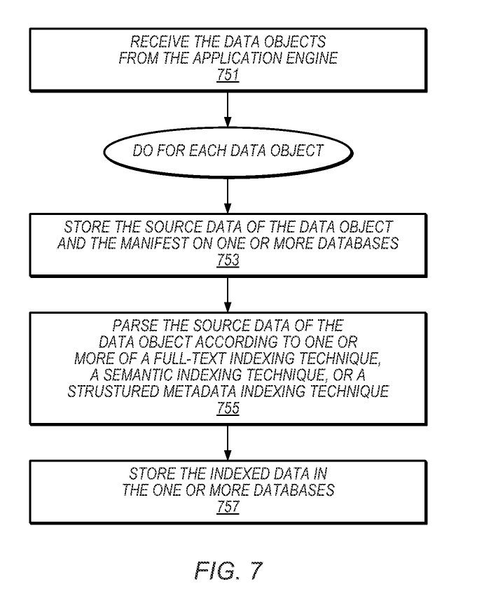

FIG. 7 is a flowchart diagram illustrating one embodiment of a method that may be performed by the semantic data container of the distributed data management system. The flowchart blocks of FIG. 7 illustrate logical operations that may be performed by the semantic data container, and in various embodiments of the method, some of the operations may be combined, omitted, modified, or performed in different orders than shown.

The semantic data container may receive the data objects from the application engine (block 751). For each data object, the semantic data container may perform the following: store the source data of the data object and the manifest in one or more databases (block 753); parse the source data of the data object according to one or more of a full-text indexing technique, a semantic indexing technique, or a structured metadata indexing technique (block 755); and store the indexed data in the one or more databases (block 757).

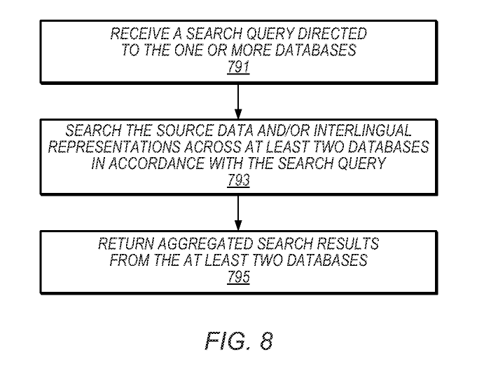

FIG. 8 is a flowchart diagram illustrating one embodiment of a method that may be performed by the database client of the distributed data management system. The flowchart blocks of FIG. 8 illustrate logical operations that may be performed by the database client, and in various embodiments of the method, some of the operations may be combined, omitted, modified, or performed in different orders than shown.

The database client may receive a search query directed to the one or more databases (block 791). The database client may then search the source data and/or interlingual representations across at least two databases in accordance with the search query (block 793), and return aggregated search results from the at least two databases (block 795).

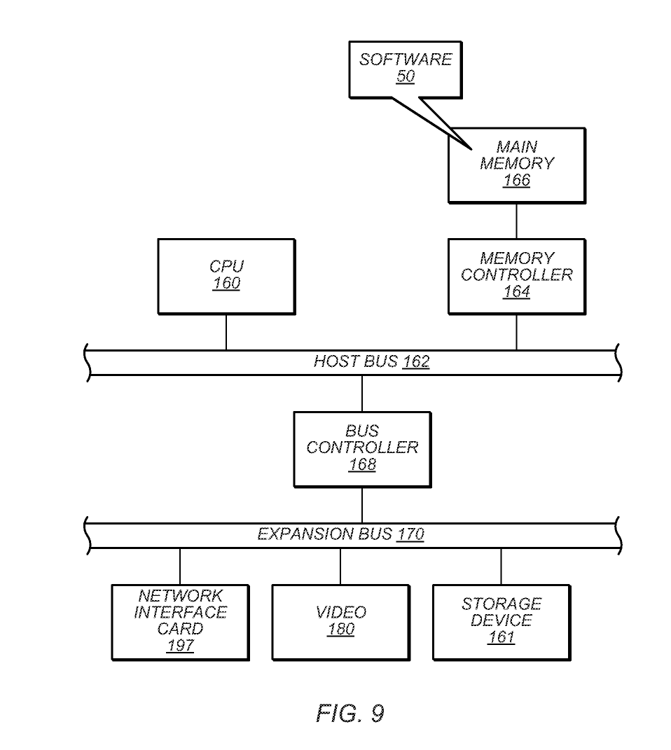

FIG. 9 illustrates one embodiment of a computer which may execute software 50 that implements functionality performed by the distributed data management system. In various embodiments, the distributed data management system may use any number of computers. Different computers may be coupled to each other and communicate via a network. For example, in some embodiments the application engine may execute on one or more computers, and the semantic data container may execute on one or more different computers. In other embodiments, the software 50 may be distributed across multiple computers in any of various other ways.

The software 50 may execute on any kind of computer or computing device(s), such as one or more personal computer systems (PC), workstations, servers, network appliances, or other type of computing device or combinations of devices. In general, the term “computer ” can be broadly defined to encompass any device (or combination of devices) having at least one processor that executes instructions from one or more storage mediums. The computer may have any configuration or architecture, and FIG. 9 illustrates a representative PC embodiment. Elements of a computer not necessary to understand the present description have been omitted for simplicity.

The computer may include at least one central processing unit or CPU (processor) 160 which is coupled to a processor or host bus 162. The CPU 160 may be any of various types. For example, in some embodiments, the processor 160 may be compatible with the x86 architecture, while in other embodiments the processor 160 may be compatible with the SPARC™ family of processors. Also, in some embodiments the computer may include multiple processors 160.

The software 50 may include program instructions executable to implement any of the operations described above with respect to the distributed data management system, e.g., operations performed by the application engine and/or semantic data container. The computer may include memory 166 in which program instructions implementing the software 50 are stored. The program instructions may be executed by the processor(s) 160.

In some embodiments the memory 166 may include one or more forms of random access memory (RAM) such as dynamic RAM (DRAM) or synchronous DRAM (SDRAM). In other embodiments, the memory 166 may include any other type of memory configured to store program instructions. The memory 166 may also store operating system software or other software used to control the operation of the computer. The memory controller 164 may be configured to control the memory 166.

The host bus 162 may be coupled to an expansion or input/output bus 170 by means of a bus controller 168 or bus bridge logic. The expansion bus 170 may be the PCI (Peripheral Component Interconnect) expansion bus, although other bus types can be used. Various devices may be coupled to the expansion or input/output bus 170, such as a video display subsystem 180 which sends video signals to a display device, as well as one or more storage devices 161. The storage device(s) 161 may include any kind of device configured to store data, such as one or more disk drives, solid state drives, or optical drives for example. In the illustrated example, the one or more storage devices are coupled to the computer via the expansion bus 170, but in other embodiments may be coupled in other ways, such as via a network interface card 197, through a storage area network (SAN), via a communication port, etc. One or more databases may be stored on the storage device(s) 161, which may be used by the semantic data container as described above.

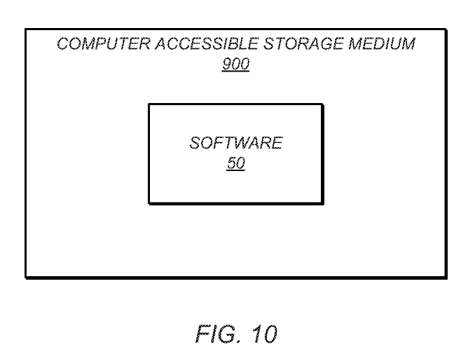

Turning now to FIG. 10, a block diagram of a computer accessible storage medium 900 is shown. The computer accessible storage medium 900 may store software 50 including program instructions executable by one or more processors to implement various functions described above. Generally, the software 50 may include any set of instructions which, when executed, implement a portion or all of the functions described herein with respect to the distributed data management system.

Generally speaking, a computer accessible storage medium may include any storage media accessible by a computer during use to provide instructions and/or data to the computer. For example, a computer accessible storage medium may include storage media such as magnetic or optical media, e.g., disk (fixed or removable), tape, CD-ROM, DVD-ROM, CD-R, CD-RW, DVD-R, DVD-RW, or Blu-Ray. Storage media may further include volatile or non-volatile memory media such as RAM (e.g. synchronous dynamic RAM (SDRAM), Rambus DRAM (RDRAM), static RAM (SRAM), etc.), ROM, Flash memory, non-volatile memory (e.g. Flash memory) accessible via a peripheral interface such as the Universal Serial Bus (USB) interface, a flash memory interface (FMI), a serial peripheral interface (SPI), etc. Storage media may include microelectromechanical systems (MEMS), as well as storage media accessible via a communication medium such as a network and/or a wireless link. A carrier medium may include computer accessible storage media as well as transmission media such as wired or wireless transmission.

Numerous variations and modifications will become apparent to those skilled in the art once the above disclosure is fully appreciated. It is intended that the following claims be interpreted to embrace all such variations and modifications.

What is claimed is:

1. A computer system comprising:
one or more processors; and
memory storing program instructions that implement an application engine and a data container;
wherein the application engine is executable by the one or more processors to:
obtain a plurality of portions of source data from one or more data sources;
for each respective portion of source data: a) map at least a subset of the source data to an interlingual representation; and b) transmit, to the data container, a data object including the source data and a corresponding manifest, wherein the manifest includes the interlingual representation;
wherein the data container is executable by the one or more processors to receive the data objects transmitted by the application engine, and for each data object:
store the source data of the data object in one or more databases;
store the manifest of the data object in the one or more databases, wherein said storing the manifest includes storing the interlingual representation of the source data of the data object;
parse the source data of the data object according to one or more of a full-text indexing technique, a semantic indexing technique, or a structured metadata indexing technique, wherein said parsing produces indexed data; and
store the indexed data in the one or more databases.

2. The computer system of claim 1, the data container is executable by the one or more processors to parse the source data of a given data object according to the full-text indexing technique, the semantic indexing technique, and the structured metadata indexing technique.

3. The computer system of claim 1, wherein the data container is executable by the one or more processors to:
receive a first data object including a first portion of source data obtained from a first data source, and a second data object including a second portion of source data obtained from a second data source;
store the source data of the first data object in a first one or more databases corresponding to the first data source; and
store the source data of the second data object in a second one or more databases corresponding to the second data source.

4. The computer system of claim 3,
wherein the manifest of the first data object includes instructions directing the data container to store the source data of the first data object in the first one or more databases, and wherein the manifest of the second data object includes instructions directing the data container to store the source data of the second data object in the second one or more databases.

5. The computer system of claim 1,
wherein the application engine includes a plurality of acquisition applications, wherein each acquisition application corresponds to a particular data source and is executable by the one or more processors to obtain source data from the particular data source.

6. The computer system of claim 1, wherein the program instructions further implement a database client, wherein the database client is executable by the one or more processors to:
receive a search query directed to the one or more databases;
search the one or more databases in accordance with the search query; and
return result information indicating a result of said searching the one or more databases.

7. The computer system of claim 6, wherein the database client is executable by the one or more processors to receive any combination of a full-text search query, semantic search query, or structured metadata search query.

8. The computer system of claim 6, wherein said searching the one or more databases comprises searching at least two databases, wherein the result information included aggregated search results from the at least two databases.

9. The computer system of claim 6, wherein said searching the one or more databases comprises searching both source data and interlingual representations stored in the one or more databases.

10. A method comprising:
executing an application engine on a computer system, wherein said executing the application engine includes:
obtaining, by the application engine, a plurality of portions of source data from one or more data sources;
for each respective portion of source data: a) mapping, by the application engine, at least a subset of the source data to an interlingual representation; and b) transmitting, to the data container, a data object including the source data and a corresponding manifest, wherein the manifest includes the interlingual representation; and
executing a data container on the computer system, wherein said executing the data container includes:
storing, by the data container, the source data of the data object in one or more databases;
storing, by the data container, the manifest of the data object in the one or more databases, wherein said storing the manifest includes storing the interlingual representation of the source data of the data object;
parsing, by the data container, the source data of the data object according to one or more of a full-text indexing technique, a semantic indexing technique, or a structured metadata indexing technique, wherein said parsing produces indexed data; and
storing, by the data container, the indexed data in the one or more databases.

11. The method of claim 10, wherein said parsing comprises:
parsing the source data of a given data object according to the full-text indexing technique, the semantic indexing technique, and the structured metadata indexing technique.

12. The method of claim 10, wherein said executing the data container includes:
receiving a first data object including a first portion of source data obtained from a first data source, and a second data object including a second portion of source data obtained from a second data source;
storing the source data of the first data object in a first one or more databases corresponding to the first data source; and
storing the source data of the second data object in a second one or more databases corresponding to the second data source.

13. The method of claim 10,
wherein the application engine includes a plurality of acquisition applications, wherein each acquisition application corresponds to a particular data source and executes on the computer system to obtain source data from the particular data source.

14. The method of claim 10, further comprising executing a database client on the computer system, wherein said executing the database client includes:
receiving, by the database client, a search query directed to the one or more databases;
searching, by the database client, the one or more databases in accordance with the search query; and
returning, by the database client, result information indicating a result of said searching the one or more databases.

15. A non-transitory computer accessible storage medium storing program instructions executable by one or more processors to implement an application engine and a data container, wherein the application engine is executable by the one or more processors to:
obtain a plurality of portions of source data from one or more data sources;
for each respective portion of source data: a) map at least a subset of the source data to an interlingual representation; and b) transmit, to the data container, a data object including the source data and a corresponding manifest, wherein the manifest includes the interlingual representation;
wherein the data container is executable by the one or more processors to receive the data objects transmitted by the application engine, and for each data object:
store the source data of the data object in one or more databases;
store the manifest of the data object in the one or more databases, wherein said storing the manifest includes storing the interlingual representation of the source data of the data object;
parse the source data of the data object according to one or more of a full-text indexing technique, a semantic indexing technique, or a structured metadata indexing technique, wherein said parsing produces indexed data; and
store the indexed data in the one or more databases.

16. The non-transitory computer accessible storage medium of claim 15, wherein the data container is executable by the one or more processors to parse the source data of a given data object according to the full-text indexing technique, the semantic indexing technique, and the structured metadata indexing technique.

17. The non-transitory computer accessible storage medium of claim 15, wherein the data container is executable by the one or more processors to:
receive a first data object including a first portion of source data obtained from a first data source, and a second data object including a second portion of source data obtained from a second data source;
store the source data of the first data object in a first one or more databases corresponding to the first data source; and
store the source data of the second data object in a second one or more databases corresponding to the second data source.

18. The non-transitory computer accessible storage medium of claim 15,
wherein the application engine includes a plurality of acquisition applications, wherein each acquisition application corresponds to a particular data source and is executable by the one or more processors to obtain source data from the particular data source.
